(19) United States
(12) Patent Application Publication
(10) Pub. No.: US 2008/0311615 A1
(43) Pub. Date: Dec. 18, 2008

(54) METHOD FOR CHIRAL SEPARATION OF LACTIC ACID ENANTIOMERS

(75) Inventors: Dean Stephen Norton, Lilburn, GA (US); James Alexander Bralley, III, Johns Creek, GA (US); Brian Shelton Crow, Atlanta, GA (US); Michael Jason Bishop, Atlanta, GA (US); Kasey David Kovalcik, Lawrenceville, GA (US); Joseph Marshall George, Sugar Hill, GA (US)

Correspondence Address: E. J. Asbury III, Esq, 1265 Lake Colony Dr, Marietta, GA, 30068, US

(73) Assignee: METAMETRIX, INC., Duluth, GA (US)

(21) Appl. No.: 11/845,555

(22) Filed: Aug. 27, 2007

Related U.S. Application Data
(60) Provisional application No. 60/823,617, filed on Aug. 25, 2006.

(51) Int. Cl. C12Q 1/04; B01D 15/08

(52) U.S. Cl. 435/34; 210/656

(57) ABSTRACT

A method for the separation and simultaneous determination of urinary D- and L-lactic acid enantiomers by high performance liquid chromatography tandem mass spectrometry (HPLC/MS/MS). The chiral separation was done using a chirobiotic teicoplanin aglycone column varying mobile phase parameters such as the acetic acid/triethylamine content and the aqueous/organic ratio.

### CROSS-REFERENCE TO RELATED APPLICATION

This application claims benefit of co-pending U.S. Provisional Patent Application No. 60/823,617, filed Aug. 25, 2006, entitled ASSAY FOR CHIRAL SEPARATION OF LACTIC ACID ENANTIOMERS IN URINE USING A TEICOPLANIN BASED STATIONARY PHASE, and commonly assigned to the assignee of the present application, the disclosure of which is incorporated by reference in its entirety herein.

### FIELD

The present invention relates to methods for separation of lactic acid enantiomers in urine or other fluid.

### BACKGROUND

Lactic acid (2-hydroxypropanoic acid, pKa 3.86) is a small organic acid of biological importance that was first isolated from sour milk by Scheele in 1780. Biochemical processes of lactic acid range from anaerobic by-product of exercise to fermentation useful for the production of yogurt, cheese and even wines. There are two optically active chiral enantiomers of lactic acid designated L-(+)-lactic acid or (S)-lactic acid (see FIG. 1A), and the mirror image D-(−)-lactic acid or (R)-lactic acid (see FIG. 1B). These two optical isomers are very different in terms of biological origin and metabolic significance. Whereas L-lactic acid is naturally occurring in mammals produced by anaerobic reduction of pyruvate, only about one percent of D-lactic acid is generated via the methylgloxylase pathway. Instead, D-lactic acid detectable in human physiological fluids often originates from bacteria present in the intestinal tract or gut. Bacterial overproduction of D-lactate in the gut is inherent to patients with short bowel syndrome (SBS) or after jejunoileal surgery. In the human gut, malabsorption of excess carbohydrates due to SBS or surgical procedure can lead to elevated amounts of both D- and L-lactate produced by intestinal flora. Eventually, this build up of excess organic acid can ultimately result in a condition known as metabolic acidosis and if left untreated, significant neurological symptoms can manifest. Therefore the analytical determination of lactic acid enantiomers especially D-lactate is warranted.

Several analytical techniques have been developed and applied for the enantiomeric separation and detection of L- and D-lactic acid including ligand exchange high performance liquid chromatography (HPLC), gas chromatography (GC), and capillary electrophoresis (CE) [2, 10-11]. More traditional methods including enzymatic assays (EA) using ultraviolet (UV) spectrophotometric and immunoturbidimetric detection have also been employed. Although these techniques provide adequate analysis, in many cases there is room for improved methodology in terms of compatibility for the clinical laboratory setting. These requirements include rapid sample preparation, the ability for high throughput as well as a detector capable of achieving low limits of detection. Consequently, the current methods that require derivatization (e.g., GC), require rigorous sample clean up (e.g., CE) such as solid phase extraction (SPE), or undergo cross reaction during the analysis (e.g., EA) can be time consuming and problematic. A common liquid chromatography method for chiral separation such as lactate employs cyclodextrin or crown ether-based stationary phases, which require nonvolatile mobile phases containing metals or salts which are often unsuitable for mass spectrometry (MS) as they contaminate the ion source. These Pirkle or cavity types of columns are mostly used for LC-ultraviolet detection, not LC-MS. The use of HPLC coupled with tandem mass spectrometry detection is a well suited alternative that can overcome many of the shortcomings inherent to current methods.

The capability of macrocyclic glycopeptide chiral columns including teicoplanin and vancomycin for complex chiral separations using HPLC has received growing interest. These phases often avoid the use of inorganic buffers and rarely require the use of classical normal phase solvents such as hexanes. Instead, the mobile phase is comprised of short chain alcohols (such as, but not limited to, methanol, ethanol, isopropanol) containing volatile salts (such as, but not limited to, ammonium salts, and acids (such as, but not limited to, acetic acid). Therefore, these mobile phases are well suited for use with MS detection.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

One aspect of the present disclosure provides a method for separation of D-lactic acid and L-lactic acid enantiomers, comprising: providing a column with which chirobiotic teicoplanin aglycone is associated; passing a test sample suspected of containing D-lactic acid and L-lactic acid enantiomers over said column; performing high performance liquid chromatography separation analysis on said test sample; and, performing tandem mass spectrometry analysis on said test sample.

Another aspect of the present disclosure provides a method for separation of D-lactic acid and L-lactic acid enantiomers, comprising: providing a column with which a macrocyclic glycopeptide chiral material is associated; passing a test sample suspected of containing D-lactic acid and L-lactic acid enantiomers over said column; and, performing high performance liquid chromatography and tandem mass spectrometry (HPLC/MS/MS) analysis on said test sample.

Another aspect of the present disclosure provides a method for simultaneous and sensitive determination of D-lactic acid and L-lactic acid enantiomers in human urine, comprising: providing a column with which chirobiotic teicoplanin aglycone is associated; passing a test sample suspected of containing D-lactic acid and L-lactic acid enantiomers over said column; performing high performance liquid chromatography separation analysis on said test sample; and, performing tandem mass spectrometry analysis on said test material.

Another aspect of the present disclosure provides a method for detecting bacterial presence or growth in a patient by detecting D-lactic acid or D-lactate in a test sample, comprising: providing a column with which chirobiotic teicoplanin aglycone is associated; passing a test sample suspected of containing D-lactic acid and L-lactic acid enantiomers over said column; performing high performance liquid chromatography separation analysis on said test sample; and, performing tandem mass spectrometry analysis on said test material.

Another aspect of the present disclosure provides a system for detecting elevated levels of L-lactic acid and D-lactic acid in a patient specimen, comprising: at least one chromatographic column which at least one macrocyclic glycopeptide chiral material is associated; and, at least one mobile phase material. The system may further comprise a mobile phase comprising short chain alcohols. The mobile phase may comprise at least one short chain alcohol, at least one volatile salt, and an acid. The macrocyclic glycopeptide chiral material may be selected from the group consisting of chirobiotic teicoplanin aglycone and vancomycin.

### BRIEF DESCRIPTION OF THE DRAWINGS

Aspects of the present invention are illustrated in the drawings which, for the purpose of convenience, but not to be interpreted as limitation, as follows:

FIGS. 1a and 1b show the chemical structure of lactic acid enantiomers.

FIG. 2a-f show chromatograms showing the effects of varying mobile phase MeOH/HOAc/TEA ratio (v/v) on the separation of D- and L-lactic acid enantiomers.

FIGS. 3a-e show chromatograms showing the effects of adding H₂O to the polar ionic mobile phase.

FIGS. 4a-d show the effects of sample matrix on the peak area under curve (AUC) and the instrument response factor relative to internal standard.

FIGS. 5a-c show scatter plots show the ranges of (a) L-lactic acid and (b) D-lactic acid obtained for approximately 130 patient urine samples.

FIG. 6 shows chromatograms of the normal and elevated controls, where normal control comprised of patient pooled urine. Elevated control is normal control spiked with 60 mg/L L-lactic acid and 24 mg/L D-lactic acid.

FIGS. 7a-c show chromatograms comparing the calibrator, patient 1 with low D-lactic acid, and patient 2 with elevated D-lactic acid.

FIG. 8 shows a table of long term stability over a three week period.

FIGS. 9-16 show the matrix evaluation for L-lactate.

FIG. 9 is a table which shows the water calibration—area under the curve.

FIG. 10 is a table which shows the water calibration—internal standard corrected response.

FIG. 11 is a table which shows the matrix calibration—area under the curve.

FIG. 12 is a table which shows the matrix calibration—internal standard corrected response.

FIG. 13 is a table which shows the student t-test where the calculated t-value is 23.03.

FIG. 14 is a table which shows the student t-test where the calculated t-value is 1.81.

FIG. 15 is a graph of the Area Under the Curve Matrix Study.

FIG. 16 is a graph of the Internal Standard Corrected Response Matrix Study.

FIGS. 17-24 show the matrix evaluation for D-lactate.

FIG. 17 is a table which shows the water calibration—area under the curve.

FIG. 18 is a table which shows the water calibration—internal standard corrected response.

FIG. 19 is a table which shows the matrix calibration—area under the curve.

FIG. 20 is a table which shows the matrix calibration—internal standard corrected response.

FIG. 21 is a table which shows the student t-test where the calculated t-value is 28.40.

FIG. 22 is a table which shows the student t-test where the calculated t-value is 1.26.

FIG. 23 is a graph of the Area Under the Curve Matrix Study.

FIG. 24 is a graph of the Internal Standard Corrected Response Matrix Study.

FIGS. 25-30 show graphs from an evaluation of interference study.

FIG. 25 is a graph of a first patient sample L-lactate and elevated D-lactate levels.

FIG. 26 is a graph of the first patient sample internal standard.

FIG. 27 is a graph of a second patient sample L-lactate and elevated D-lactate levels.

FIG. 28 is a graph of the second patient sample internal standard.

FIG. 29 is a graph of the mixed patient samples L-lactate and elevated D-lactate levels.

FIG. 30 is a graph of the mixed patient samples internal standard.

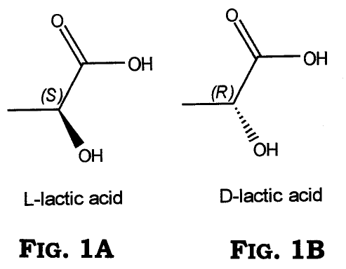

### DETAILED DESCRIPTION

The aspects and features of the present disclosure can be embodied in various forms. The following description and examples show, by way of illustration, combinations and configurations in which the aspects can be practiced. It should be understood that the described aspects and/or embodiments are merely examples and that other aspects and/or embodiments can be utilized. It should further be understood that structural, parametrical and functional modifications of the aspects, features, and embodiments described herein can be made without departing from the scope of the present disclosure.

An aspect of the present invention provides a combination of techniques for the rapid and sensitive separation of lactic acid enantiomers. In one aspect, a macrocyclic glycopeptide chiral column is provided. One exemplary column is a teicoplanin-based column. One aspect of the present invention provides a method for the chiral separation of lactic acid enantiomers using gas chromatography incorporating a teicoplanin-based column and also using tandem mass spectrometry. The combination of the particular GC column and tandem MS (HPLC/MS/MS) provides a selective separation of enantiomers in a rapid time frame heretofore not demonstrated in the art for biological analysis of lactic acid enantiomers. One aspect of the present invention obviates the need for metal compositions for enantiomeric selectivity.

One aspect of the present disclosure describes a method for simultaneous and sensitive determination of D- and L-lactic acid enantiomers in urine by HPLC/MS/MS using a teicoplanin based column coupled to tandem MS for fast biological analysis of lactic acid enantiomers in human urine.

### EXAMPLES

The invention will be further described in connection with the following examples, which are set forth for purposes of illustration only. Parts and percentages appearing in such examples are by weight unless otherwise stipulated.

### Example 1

### 1.1 Instrumentation and Reagents

Chromatographic separations were performed on a Waters (Milford Mass., USA) 2695 high-performance liquid chromatograph (HPLC). Samples were analyzed on a Waters Quattro-LC tandem mass spectrometer equipped with an electrospray ionization source. All analytes were detected in electrospray (−) ionization mode. The collected data was processed using MassLynx (v4.0).

Triethylamine (TEA) 99%, and L(+)-lactic acid 98%, and thymol 99.5% were obtained from Sigma-Aldrich (St. Louis, Mo., USA). D-lactic acid sodium salt 99% was purchased from Fluka, a division of Sigma-Aldrich. HPLC grade ethanol (EtOH) and methanol (MeOH) were obtained from Burdett and Jackson (Muskegon, Mich., USA). Glacial acetic acid (HOAc) was purchased from J. T. Baker (Phillipsburg, N.J., USA). Saline solution 0.85-0.90% (w/v) was obtained from VWR (West Chester, Pa., USA). The internal standard, sodium L-Lactate-3,3,3-D₃ (99.8% atom % D) was purchased from CDN Isotopes (Quebec, Canada).

### 1.2 Mass Spectrometry Conditions

Initially, the in-line infusion of standard L-lactic acid (100 mg/L) and D-lactic acid (16 mg/L) into the MS was performed in order to establish the most sensitive operating conditions. Table 1 shows the optimized MS parameters for electrospray negative mode.

TABLE 1
Optimized mass spectrometry settings.
Source (ES-)

| | |
|---|---|
| Capillary (kV) | 1.50 |
| Cone (V) | 25 |
| Extractor (V) | 1 |
| RF Lens (V) | 0.1 |
| Source Temp. (° C.) | 145 |
| Desolvation Temp. (° C.) | 350 |
| Cone Gas Flow (L/Hr) | OFF |
| Desolvation Gas Flow (L/Hr) | 25 |

Analyzer:

| | |
|---|---|
| LM 1 Resolution | 15 |
| HM 1 Resolution | 15 |
| Ion Energy 1 | 1 |
| Entrance | −5 |
| Collision | 11 |
| Exit | 1 |
| LM 2 Resolution | 15 |
| HM 2 Resolution | 15 |
| Ion Energy 2 | 1.0 |
| Multiplier (V) | 650 |

MRM:

| | Parent (m/z) | Daughter (m/z) |
|---|---|---|
| Lactic acid | 89.2 | 43.4 |
| Internal standard | 92.0 | 45.0 |

For multiple reaction monitoring (MRM), the parent molecule [M-H]⁻ of lactic acid was equal to 89.2 m/z and the daughter ion was found to be 43.4 m/z which were both collected at unit mass resolution with a dwell time of 0.33 s. The MRM of the deuterated internal standard was 92.0 and 45 m/z for parent and daughter ions respectively. For increased sensitivity, the nebulizer gas was set to zero. These settings were utilized for the examples and experiments described hereinbelow.

### 1.3 Chromatographic Conditions

The separation was conducted using a chirobiotic teicoplanin aglycone (TAG) chiral column, 150×2.1 mm, (Advanced Separation Technologies, Whippany, N.J., USA). Isocratic mobile phase conditions were utilized which consisted of 17% mobile phase A=deionized H₂O, 23% mobile phase B=EtOH+0.5% (v/v) HOAc, and 60% mobile phase C=EtOH+0.5% (v/v) TEA. The sample injection volume was 25 μL and total run time was 7.5 minutes. The column temperature and flow rate were optimized to 25° C. and 0.2 mL/min respectively.

### 1.4 Calibration Standard and Sample Preparation

Nine standard calibrator solutions covering high and low range were prepared and used to establish the accuracy and linearity of the method as shown in Table 2.

TABLE 2
Concentrations (expressed in mg/L) of the nine standard
calibrant solutions used for validation

| Calibr. # | L-lactic acid | D-lactic acid |
|---|---|---|
| Cal #9 | 1000.0 | 160.8 |
| Cal #8 | 500.0 | 80.4 |
| Cal #7 | 200.0 | 32.2 |
| Cal #6 | 100.0 | 16.1 |
| Cal #5 | 50.0 | 8.0 |
| Cal #4 | 25.0 | 4.0 |
| Cal #3 | 12.5 | 2.0 |
| Cal #2 | 6.3 | 1.0 |
| Cal #1 | 3.1 | 0.5 |

In order to more closely match the urine sample matrix of the patient sample, calibrators were constituted in saline solution. Deuterated (D₃)-L-lactate was used as an internal reference standard. Calibrators were sequentially prepared from a stock solution (Cal 9) using saline for equal volume dilution of each calibrant. The concentration of the standards are shown above in Table 2. For the internal standard (I.S.), 40 μg/mL of deuterated D₃-L-lactic acid was prepared by weighing 2 mg into 50 mL volumetric flask using saline to fill to the mark. Next, 9.1 mL of this solution was transferred to a 100 mL volumetric flask using a glass volumetric pipette. This was followed by addition of EtOH to fill to the mark.

The final working solution for calibration was prepared by transferring 300 μL of calibrator to a sample vial followed by addition of 900 μL of the I.S. solution. This solution was briefly vortexed prior to injection. Human urine samples were collected in tubes containing 20 μL of thymol (0.05 mg/mL) as a preservative, and stored at −20° C. For patient sample preparation, 300 μL of urine was transferred to a 1.7 mL micro centrifuge bullet tube followed by addition of 900 μL I.S. solution. The tube was then vortexed briefly to mix. The bullet was centrifuged at 7000 rpm for 5 minutes and the resulting supernatant was transferred using glass pipette to the sample vial avoiding collection of any solid precipitate.

### 1.5 Urinary Creatinine Measurement

Urinary creatinine concentration was measured on a Cobas Mira Plus using a creatinine assay kit obtained from Roche (Quebec, Canada) following Jaffe's picric acid method.

### 1.6 Patient Ranges

Patient ranges were established using intra-laboratory urine samples. All concentration measurements were normalized to creatinine. Data was collected from approximately 130 samples to calculate a working within laboratory range for both normal and elevated results. The ranges established are relevant to patients 13 years of age and older.

### 1.7 Preparation of Quality Control Samples

For quality control (QC) sample, normal and elevated controls were prepared from pooled urine. Elevated controls were prepared by weighing a known amount of L-, D-lactic acid into the normal control urine. Both the normal and elevated controls were aliquoted then stored in the freezer at −20° C.

### 1.8 Matrix Effects Study

For determination of ion suppression effects due to variation in sample matrix, a comparison of the area under the curve (AUC) versus the response factor (ratio of analyte divided by internal standard area) was conducted for calibrators in saline versus two urine matrices. Following the experimental protocol described by Annesley (see, T. M. Annesley, Clin. Chem. 49:7 (2003) 1041, a similar study was designed for the present study. First, six tubes containing 500 μL of pooled urine were blown to dryness using N₂ at 50° C. for 40 min. Next, five calibrators (#9,7,5,3,1) in saline plus a blank were used to reconstitute the dried urine. For comparison, the second urine matrix was comprised of standards D- and L-lactic weighed directly into pooled urine. All matrix study samples were then prepared in the same fashion as normal calibrators. A comparison of the instrument response to three sets of calibrators was then evaluated. The student's t-test was used to compare the statistical difference between the slopes of the three calibration curves.

### 1.9 Sensitivity

Sensitivity was evaluated by the determination of limit of detection (LOD) and limit of quantification (LOQ) using the linear regression approach, such as, for example, as describe in J. Mocak, A. M. Bond, S. Mitchell, G. Scollary, Pure & Appl. Chem., 69 (1997) 297. The LOD and LOQ were calculated at a signal to noise ratio of 3 and 10, respectively.

### 1.10 Method Validation

Method validation was based upon linearity, accuracy, precision, and sample stability. Linearity was evaluated by using a nine point calibration curve. The accuracy was determined by conducting a spiked recovery experiment. The precision was assessed for both intraday (within run) and interday (between run). The normal and elevated controls were used for the evaluation of precision. Finally, the short term stability of sample preparation was determined from quantitative results of three samples stored at 5° C. on the HPLC instrument over a three day period. The long term stability was evaluated using normal and elevated controls stored at room temperature, refrigerated, frozen and finally freeze-thawed.

### 1.10.1 Linearity and Accuracy

The linear calibration curve was comprised of nine calibration levels as shown in Table 2. The linearity was determined by linear regression, including the intercept (y=m×+b) and weighted by 1/x. All calculations were performed using EP Evaluator 6 software, (RHOADS, Kennett Square, Pa., USA) and MassLynx (v.4.0).

Accuracy of the method was evaluated by performing a spiked recovery experiment. For this, a mixture of pooled patient samples was spiked with a standard solution of no more than 10% initial patient volume. A baseline was obtained by running pooled urine spiked with 10% (urine volume) of saline. The results were calculated based on the average of four successive measurements for each level.

### 1.10.2 Precision

Within run precision was calculated using normal and elevated (n=10) controls over one day. Between run precision was determined using normal and elevated controls (n=20) over a ten day period.

### 1.10.3 Short Term Stability of Sample Preparation

The short term stability of the patient sample following preparation was determined over a period of three days (72 hours). Three patient samples were prepared and stored on the instrument at 5° C. Following the initial measurement on day 1, the samples were analyzed at 24 hour intervals for three consecutive days. The stability was evaluated by a comparison of the mean value of each sample with the initial value and reported as a percentage of the initial value.

### 1.10.4 Long Term Stability of Sample Storage

In order to assess the stability of shipped and received samples, the long term stability of the patient sample was evaluated over a period of three weeks. For this, a pooled patient urine was collected and spiked with 3 levels of D-,L-lactic acid as follows. Sample A was prepared by adding 100 mg/L L-lactic acid and 40 mg/L D-lactic acid to the pooled urine, sample B was 50 mg/L L-, 20 mg/L D-, sample C was 25 mg/L L-, 10 mg/L D-, and sample D was un-spiked. Aliquots of 14 mL pooled urine were then placed into specimen collection tubes containing 20 μL of thymol preservative. The unspiked samples were then run experimentally in order to measure the baseline (Day 1=baseline). Next, all specimens were frozen overnight, the next day removed and put into shipping boxes containing ice packs in order to simulate being shipped to the laboratory. After being stored an additional day at room temperature in the shipping boxes (Day 2), the samples were then run experimentally (Day 3=received). Then all samples were aliquoted in order to test the effects of storage conditions. All four levels of sample were measured after storing at room temperature (RT), freezer (F), refrigerator (R), and freeze/thawed (FT). Initially, all samples were run for three consecutive days (Day 3,4,5) to evaluate stability. Determination of three week stability (W1-W3) was then conducted for RT, F, and R storage. The effects of FT were evaluated on Day 3-5 to establish the effects of freezing then thawing the patient sample. The % difference of each measurement from the initial value was reported.

### Results and Discussion

### Optimization of the MS Detection

Briefly, the most sensitive electrospray settings were established as mentioned in the experimental section by in-line infusion utilizing optimized mobile phase conditions. The molecular ion [M-H]⁻ of lactic acid was able to be detected using electrospray negative mode. The internal standard was chosen due to similarity of structure and ionization closely matching that of the analyte. For monitoring of parent and daughter ions, MRM channels were obtained by expanding the respective spectral region to the apex of the peak corresponding to the parent and daughter ions of lactic acid. Following this, the signal intensity of both ions was set to maximum by careful and systematic variation of the ESI operating variables.

### Optimization of the HPLC Chiral Separation

The chromatographic chiral separation of the D- and L-lactic acid enantiomers was optimized by systematic tuning of the liquid chromatography (LC) mobile phase composition. A middle level calibrator (Cal 6, Table 2) was used throughout the optimization. Isocratic conditions were evaluated as these provide faster analysis without the need for column re-equilibration steps, as time is an important factor in the clinical laboratory setting. The Chirobiotic TAG column was chosen since the polar ionic stationary phase is well suited for the separation of small polar molecules such as lactic acid. For the initial screening and investigation, a suitable starting mobile phase composition consisting of MeOH along with small volume addition of acetic acid and TEA were selected. For this, three bottles for mobile phase were set up. The first mobile phase (MPA) contained pure MeOH, the second mobile phase (MPB) was MeOH with 0.5% acetic acid, the third mobile phase (MPC) contained MeOH with 0.5% TEA. This setup allowed the varying percentage of acid or base to be delivered into the pure MeOH (MPA) thus controlling the acid to base ratio. Since the chiral stationary phase contains ionizable groups such as amines, amides, carboxylic acids, and phenols, the addition of acid and base (i.e., HOAc versus TEA) allows for the possibility of retention based on an ion exchange mechanism.

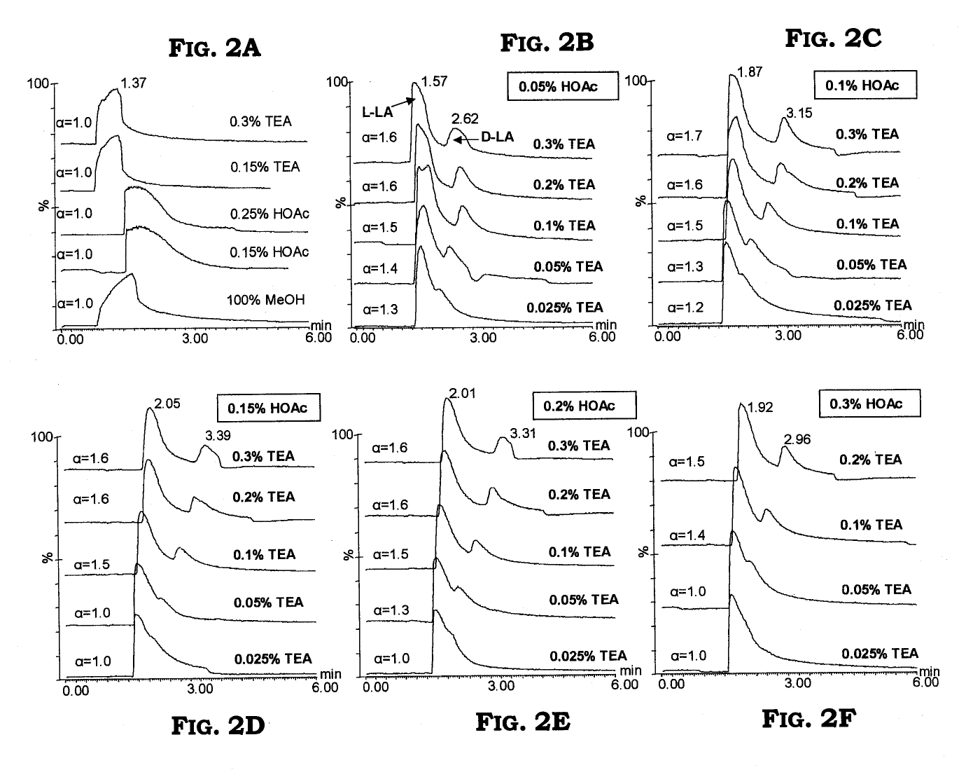

The optimization of the ion exchange mechanism was evaluated by experimentally varying the percentage of MPB and MPC on column. The results of the experiment can be seen in FIG. 2. Conditions: flow rate 0.35 mL/min, temperature 25° C., injection volume 25 μL. For ESI-MS conditions please see experimental section. Analytes: L-lactic acid 100 mg/L, D-lactic acid 16 mg/L. No separation was observed when using 100% MPA or when varying percentages of HOAc and TEA alone (FIG. 2(a)). However, it is clear that addition of HOAc promotes greater retention while the addition of TEA reduces peak tailing. Next, the effects of maintaining a fixed HOAc percentage while varying the TEA concentration were examined (FIG. 2 (b-f)). In general, increasing the mobile phase concentration of TEA resulted in greater chiral separation when the concentration of HOAc was held constant. We observed a decrease in tailing for D-lactic acid and improved peak shape from 0.1-0.2% HOAc. Overall, we established that 0.15% HOAc and 0.3% TEA was an adequate starting point for further optimization of the chromatography.

As seen in FIG. 2, the retention time of both enantiomers is near the void, suggesting that the small polar lactic acid has a high affinity for the polar MeOH mobile phase. Therefore, the effects of adding or combining a more non-polar organic solvent to the mobile phase was investigated. First, the addition of EtOH to the MeOH containing HOAc/TEA mobile phase was conducted and dramatic improvements in the separation were observed. From this observation, while the ratio of HOAc/TEA was maintained, MeOH was replaced with EtOH in all mobile phases. This change resulted in greater retention of each enantiomer at the cost of peak broadening and run time (data not shown). Therefore, in order to increase the overall efficiency, the addition of water to the mobile phase was investigated.

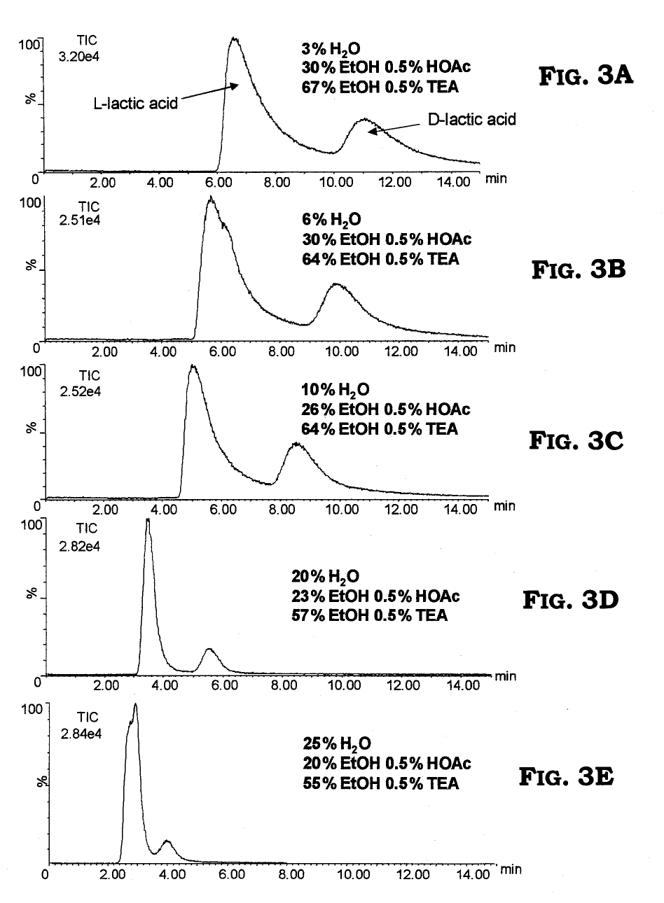

The effects of adding H₂O to EtOH can be seen in FIG. 3. Conditions are the same as FIG. 2 except HOAc/TEA as shown and the flow rate was 0.2 mL/min. Over the range of 3% to 20% addition of H₂O, a reduction in retention was observed along with improvement in the resolution. Going from 20% to 25% H₂O, the retention continued to decrease, and the extent of baseline resolution was diminished. Optimum separation conditions were found in the presence of 17% water (data not shown) as greater than 20% decreased the resolution. From this study, the final optimized conditions of 17% H₂O, 0.115% HOAc in EtOH and 0.3% TEA in EtOH were established as the final mobile phase conditions.

From the results of our systematic optimization of the mobile phase compositions, while not intending to be bound by any particular theory, several conclusions regarding the possible mechanism of retention and separation can be reached. The chiral separation of lactic acid enantiomers is believed to be the result of three stationary phase interactions. The first involves the electrostatic interaction of lactic acid with stationary phase amines. This interaction is promoted by the addition of TEA and HOAc to the mobile phase. The basic character of TEA is believed to facilitate the ionization of lactic acid to the respective conjugate base, while the addition of HOAc is thought to help ionized basic stationary phase amines to their respective conjugate acid. The action of these mobile phase additives on both analyte and stationary phase result in the electrostatic interactions between the two. The second interaction relates to the possibility of lactic acid forming hydrogen bonds between the alpha hydroxyl group and the peptide amido groups of the stationary phase. This results in the appropriate chiral docking with the stationary phase that results in the enantiomeric separation observed. The third and final point can be summarized as small hydrophobic and weak steric interactions which are considered negligible given that lactic acid is a very hydrophilic small molecule. Overall, the optimized ratio of 0.115% HOAc with 0.3% TEA are consistent with the three point mechanism. For the addition of H₂O to the mobile phase, it can be suggested that the improved solubility of hydrophilic lactic acid in the more polar mobile phase enhances the peak shape and reduces retention. Furthermore, it is possible for the stationary phase to undergo a conformational change in the presence of water that alters the distance for hydrogen bonding as mentioned in step two above. In this manner, the careful and systematic evaluation of the chromatography was assessed.

### Evaluation of Matrix Effects

Matrix effect is the effect on an analytical method caused by all other components of the sample except the specific compound to be quantified. Matrix effects and selectivity issues have long been associated with bioanalytical techniques. However the high incidence of matrix effects in liquid chromatographic tandem mass spectrometric (LC-MS-MS) methods has led to a greater understanding of the factors which contribute to these effects. A number of approaches have been investigated to improve reproducibility and robustness of LC-MS-MS methods that are subjected to matrix effect.

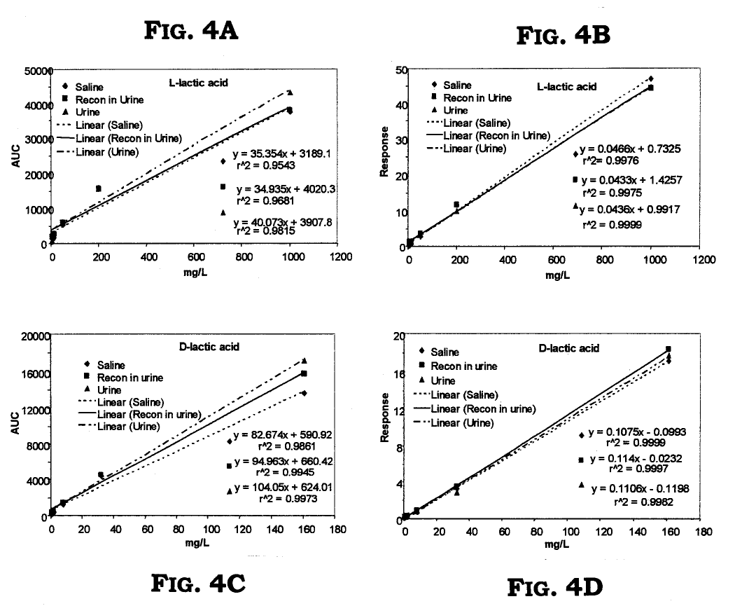

Variation of the sample matrix has been shown to contribute to ion suppression using MS detection. Therefore, a comparison of sample matrix effects on the MS response was conducted. Normal working solutions of calibrators dissolved in saline were compared to the same calibrators prepared in two urine matrices. The first urine matrix was made by drying down pooled urine followed by reconstituting with calibrator in saline. The second urine matrix was prepared by weighing standard L-,D-lactic acid directly into pooled urine. Matrix effects were evaluated by comparing the area under the curve (AUC) to the response factor ratio of standard area divided by internal standard area. From FIG. 4, a comparison of the peak area under the curve (AUC) for both L-D-lactic acid shows that similar results were obtained between the three matrices. Conditions are the same as FIG. 3 except 17% H₂O, 0.115% HOAc in EtOH and 0.3% TEA in EtOH. Slight variation in the slopes as well as poor correlation were observed. When using the internal standard response factor, the three matrices agree more closely for both enantiomers, supported by similar slope and higher r² values. Although minor effects of ion suppression were observed when considering the AUC, a comparison of the slopes for all best fit lines was shown to pass the student t-test for t_{calculated}<t_{table} (data not shown). As expected, the results showed that the deuterated internal standard allows for the correction of sample matrix effects.

### Sensitivity

The LOD (S/N=3) and LOQ (S/N=10) were determined experimentally (n=3) based upon the linear regression from the established linear range of calibration [20]. For L-lactic acid, the LOD was found to be 0.2 mg/L with LOQ of 0.5 mg/L. For D-lactic acid, the LOD was found to be 0.4 mg/L with LOQ of 1.3 mg/L.

### Example 2

### Method Validation

### 2.1 Linearity and Accuracy

The linearity was evaluated based on the average of nine calibrators (n=2) and a blank calculated from a standard curve. For both enantiomers, acceptable linearity and recovery were achieved. The linearity data and calculations for all analytes are presented in Table 3.

TABLE 3
Summary of the linearity performance parameters.

| Linearity Summary | | |
|---|---|---|
| EP Evaluator (v.6) | MassLynx (v.4.0) | |
| L-lactic acid | | |
| Slope 1.01 | y = 0.060x + 0.097 | r = 0.9990 r² = 0.9980 |
| Intercept −0.06 | y = 0.052x + 0.045 | r = 0.9997 r² = 0.9994 |
| Obs. Err. 5.60% | | |
| N 9 | | |
| D-lactic acid | | |
| Slope 1.02 | y = 0.122x + 0.039 | r = 0.9994 r² = 0.9988 |
| Intercept −0.04 | y = 0.106x + 0.041 | r = 0.9970 r² = 0.9941 |
| Obs. Err. 7.70% | | |
| N 9 | | |

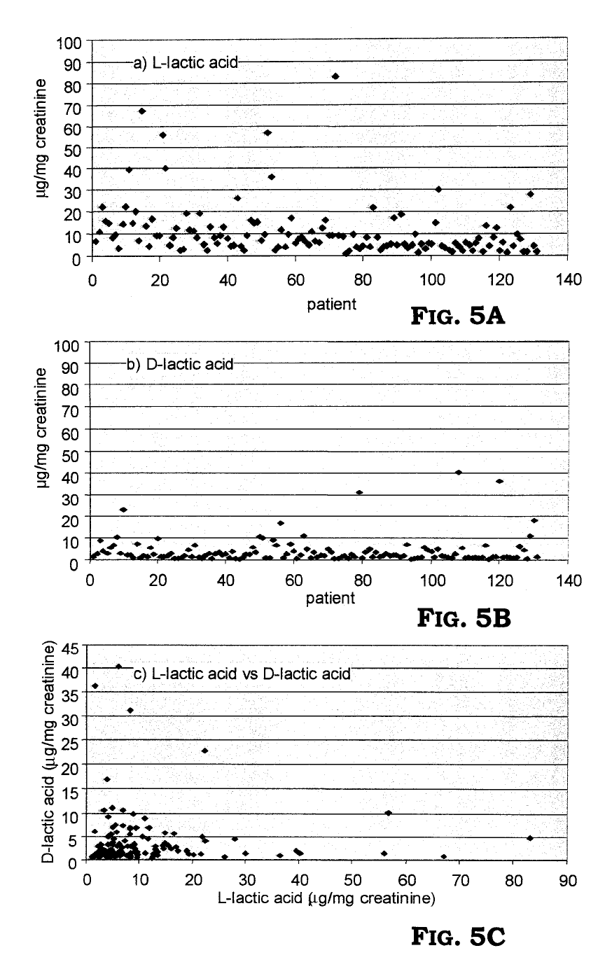

The calibrators were run in duplicate. The conditions were the same conditions as used in the method from which the data in FIG. 5 was obtained.

For EP Evaluator (v.6), the observable error based upon the linearity of calibration was found to be less than 8% for both enantiomers. In addition, using MassLynx, the acceptable r² correlation of greater than 0.9940 for both analytes was achieved.

The accuracy of the assay was evaluated based on the percent recovery for five levels of spiked urine samples compared with a baseline of pooled urine. These spiked levels were chosen to represent the entire calibration range. The average percent recoveries are presented in Table 4, which shows that the percent deviation from the theoretical value for the recovered spike was less than 15% except in one case at level 1 for L-lactic acid.

TABLE 4
Summary of the spiking and recovery

| | Spike (mg/L) | | Spike (mg/L) | | |
|---|---|---|---|---|---|
| | L-lactic | | D-Lactic | | |
| | acid | % Recovery | acid | % Recovery | |
| Level 5 | 400 | 85.4 | 64.0 | 113.0 | |
| Level 4 | 200 | 85.2 | 32.0 | 102.7 | |
| Level 3 | 100 | 90.8 | 16.0 | 101.3 | |
| Level 2 | 50 | 89.2 | 8.0 | 89.1 | |
| Level 1 | 10 | 81.7 | 2.0 | 95.9 | |
| | | 86.5 | | 100.4 | Avg. |
| | | 3.6 | | 8.8 | St. Dev. |
| | | 4.1 | | 8.8 | % RSD |

All samples run four times (n = 4), average is reported. Percent recovery calculated as follows: ((experimental − base)/calculated) × 100. Conditions: run under optimized conditions.

### 2.2 Patient Ranges and Precision

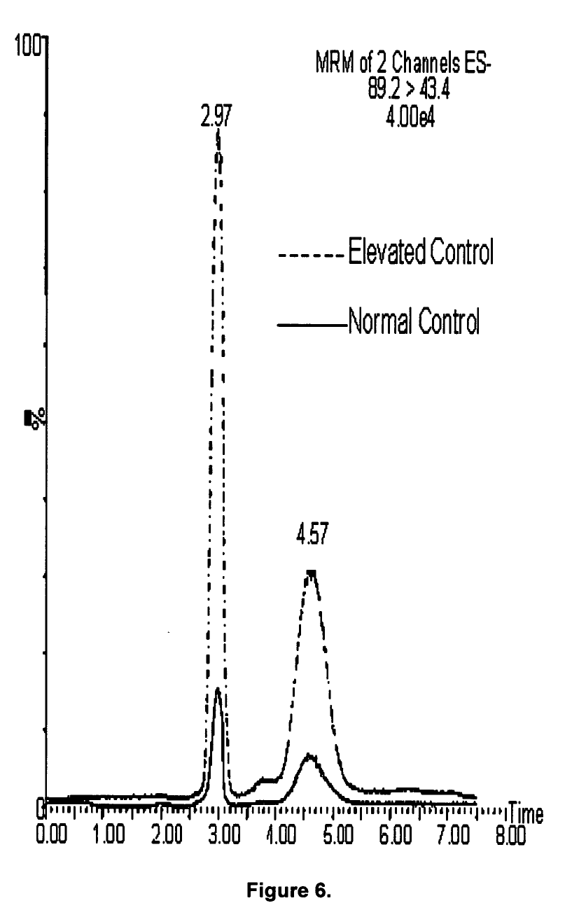

Adult normal and elevated patient ranges were determined from approximately 130 intra-laboratory samples. The normal range was established using the 95% confidence interval based upon the collected patient data. Any values above this range was considered elevated. The established ranges, corrected for creatinine, are presented in FIG. 5 (a-b). Conditions were the same as the conditions in the procedures relating to the data shown in FIG. 4. For L-lactic acid, FIG. 5(a) shows that the majority of samples were between 0-20 μg/mg creatinine and the upper limit was found to be 85 μg/mg creatinine. Therefore, we chose the elevated control value equal to 60 μg/mg creatinine. For D-lactic acid, FIG. 5(b) indicates that that the range of normal values were between 0-5 μg/mg creatinine with an upper limit of 40 μg/mg creatinine. Therefore, for D-lactic acid the elevated control was chosen as 30 μg/mg creatinine. FIG. 5(c) shows the correlation between L- and D-lactic acid for the patient samples. Finally, an example chromatogram showing the normal and elevated controls can be seen in FIG. 6 (conditions were the same as the conditions in the procedures relating to the data shown in FIG. 4) which demonstrates the increase in signal and peak area upon addition of the standard enantiomers into normal control urine.

Precision was assessed using normal and elevated controls. For the intraday precision, ten samples of each control were evaluated in one run. As shown in Table 5, the within-run (intraday) precision was less than 6% for all normal controls and no greater than 4% for elevated controls.

TABLE 5
Precision of normal and elevated controls in urine

| Normal Control | | Elevated Control | |
|---|---|---|---|
| L-lactic | D-lactic | L-lactic | D-lactic |
| acid | acid | acid | acid |

Intraday (within run)

| | | | | |
|---|---|---|---|---|
| Mean Concentration, mg/L | 11.4 | 3.6 | 69.0 | 23.7 |
| % RSD | 2.9 | 5.3 | 3.9 | 3.4 |

Interday (between run)

| | | | | |
|---|---|---|---|---|
| Mean Concentration, mg/L | 10.6 | 3.8 | 67.1 | 24.3 |
| % RSD | 6.9 | 14.6 | 4.8 | 10.7 |

a) Intraday n = 10, Interday n = 20. The conditions were the same as the conditions in the procedures relating to the data shown in FIG. 5.

For interday (between run) precision, two normal (n=2) and elevated controls (n=2) were run over a period of ten days. The precision was less than 7% for L-lactic acid both normal and elevated control. For D-lactic acid the between run variation was higher although acceptably less than 15%. 2

### 2.3 Sample Stability and Analysis of Patient Urine

First, the short term preparation stability of the sample was evaluated by analysis of three patient samples over a period of 72 hours when stored in the refrigerated HPLC sample compartment at 5° C. Table 6 shows that for each patient sample, an acceptable deviation of concentration was obtained which was less than 8% relative standard deviation (RSD).

TABLE 6
Short term three day preparation stability of patient sample.^{a,b}

| | Percentage of initial value | | | | | |
|---|---|---|---|---|---|---|
| | 24 hour | | 48 hour | | 72 hour | |
| | L-lactic acid | D-lactic acid | L-lactic acid | D-lactic acid | L-lactic acid | D-lactic acid |
| Patient Sample 1 | −2.6 ± 4.0 | −0.7 ± 0.9 | −7.6 ± 4.6 | 6.5 ± 0.4 | −3.4 ± 1.4 | −0.3 ± 4.1 |
| Patient Sample 2 | 0.2 ± 0.9 | 1.0 ± 9.3 | −3.8 ± 0.9 | 1.3 ± 7.4 | −3.4 ± 1.2 | −0.8 ± 6.2 |
| Patient Sample 3 | −5.1 ± 0.6 | −0.2 ± 0.2 | −1.9 ± 0.9 | 2.5 ± 0.5 | −1.4 ± 1.3 | −1.1 ± 0.9 |

^{a}avg. ± st. dev. (n = 3)
^{b}Conditions: same as FIG. 5.

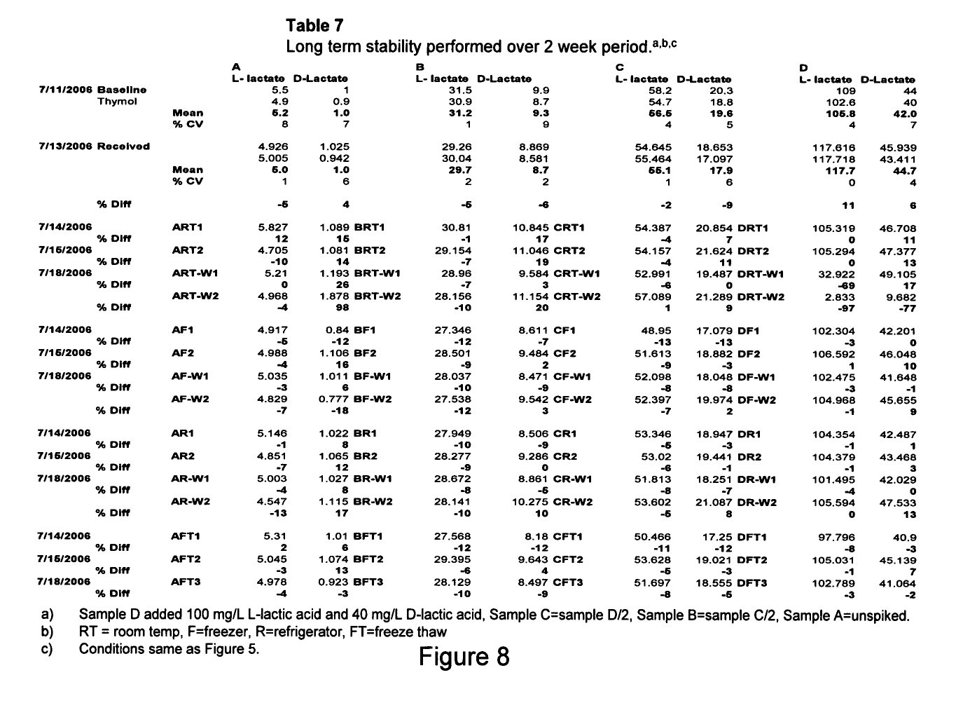

Therefore, it can be concluded that samples were stable for at least three days under the experimental conditions. For longer term stability, the effects of storing the urine sample at room temperature (RT), frozen (F) (−20° C.), refrigerated (R) (5° C.), and freeze thaw (FT) cycles were examined. FIG. 8 shows that acceptable deviation from the initial value was achieved when using either refrigerator, freezer and freeze thaw cycles over a two week period.

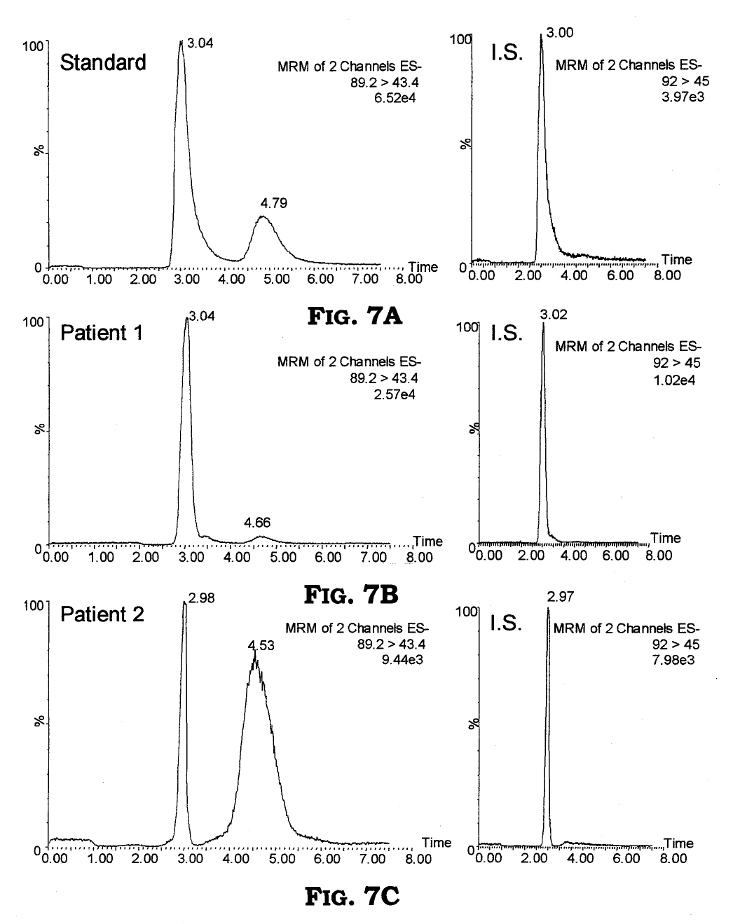

After three weeks, all samples were found to be stable with the exception of sample B which had ˜25% deviation from the initial value. The long term storage at room temperature storage of samples was shown to not be stable. Finally, the effect of thymol sample preservative was found to have no interference. For this experiment, internal standard in EtOH (900 μL) was added to appropriate aliquot of thymol (300 μL) then analyzed as a patient sample. As expected, the results showed that only the signal from internal standard was observed, and that no signal was present for MRM of lactic acid (89.2>43.4). For analysis of patient sample with elevated D-lactic acid, FIG. 7 provides representative chromatograms showing the standard calibrator (Cal 6), patient 1 with normal level of D-lactic acid, and patient 2 with elevated level. The MRM of the internal standard is provided for reference.

### Example 3

### Matrix Effect Study 2

The following matrix effect study was designed to evaluate any statistically significant change in the slopes of standard curves carried out in the presence and absence of matrix. Additionally, the method allowed for the evaluation of internal standards to correct for any effect due to matrix (i.e., ion suppression).

Calibrators were prepared in water and in matrix from a standard solution. A suitable internal standard was added and the resulting solution was carried out through the sample preparation method and chromatographic separation. This procedure was carried out in duplicate and the results were averaged. A plot of analyte concentration vs. average analyte area under the curve was generated for the water and matrix calibrators. The slopes from each curve were compared statistically.

The t-value is calculated as:

$$t = \frac{{\overline{x}}_{1} - {\overline{x}}_{2}}{\sqrt{A * B}}$$

$$A = \frac{( {n}_{1} + {n}_{2} )}{{n}_{1} * {n}_{2}}$$

$$B = \frac{( {n}_{1} - 1 ) {s}_{1}^{2} + ( {n}_{2} - 1 ) {s}_{2}^{2}}{{n}_{1} + {n}_{2} - 2}$$

where x=slope; n=degrees of freedom; and, s=standard deviation.

The t-value at 95% confidence (p=0.05) and a total of 6 degrees of freedom [(4+4)−2] was 2.45. If the calculated t-value is less than 2.45 then the two slopes are considered to be statistically the same indicating no matrix effects are present. Conversely, if the calculated t-value is greater than 2.45 then a matrix effect is present and must be addressed.

To evaluate the internal standard's ability to compensate for possible matrix effects, a plot of analyte concentration vs. average analyte response (analyte area/internal standard area) was generated for the water and matrix calibrators. The slopes from each curve were compared statistically.

The t-value at 95% confidence (p=0.05) and a total of 6 degrees of freedom [(4+4)−2] is 2.45. If the calculated t-value is less than 2.45 then the two slopes are considered to be statistically the same indicating proper function of the internal standard. Conversely, if the calculated t-value is greater than 2.45 then the internal standard is inappropriate for the analyte.

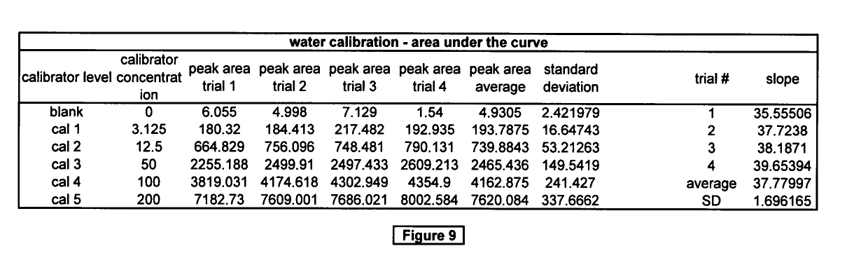

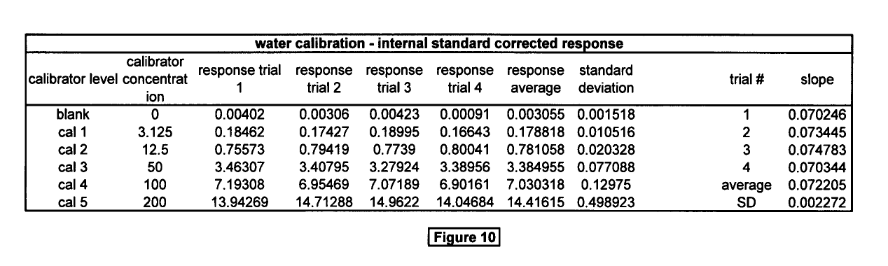

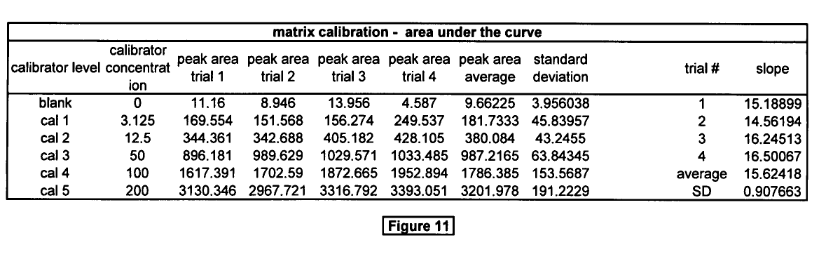

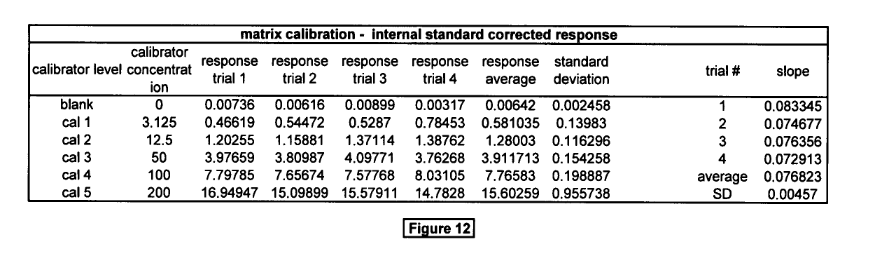

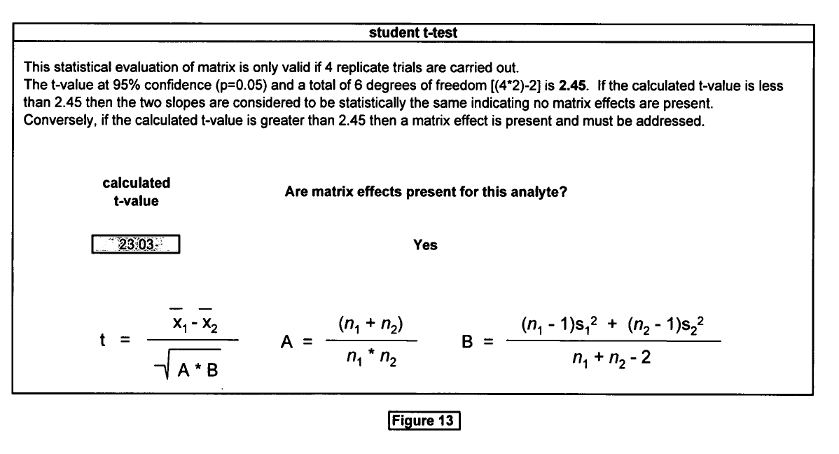

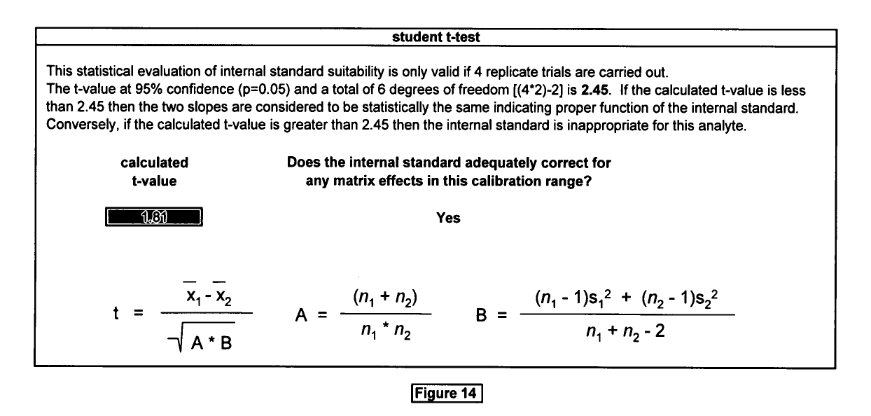

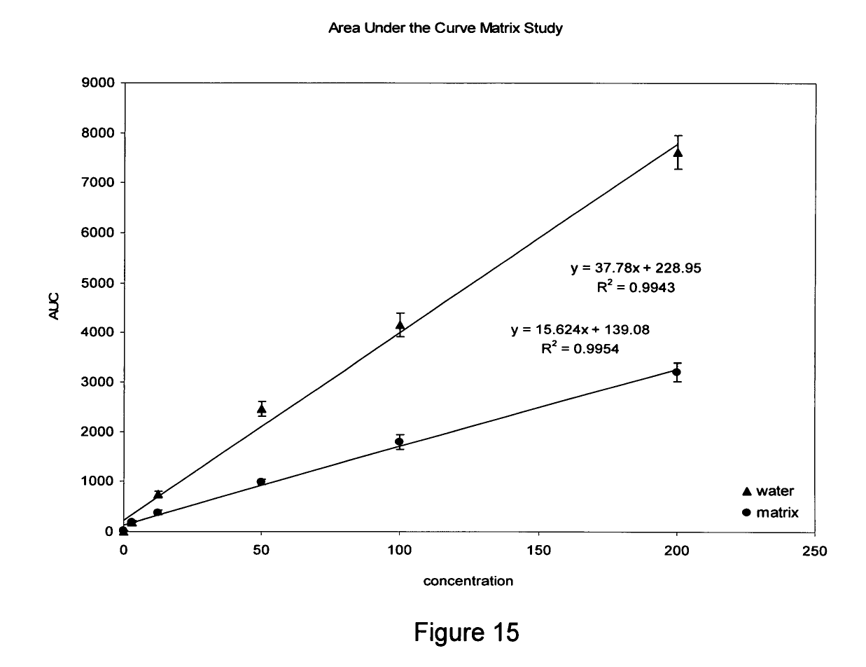

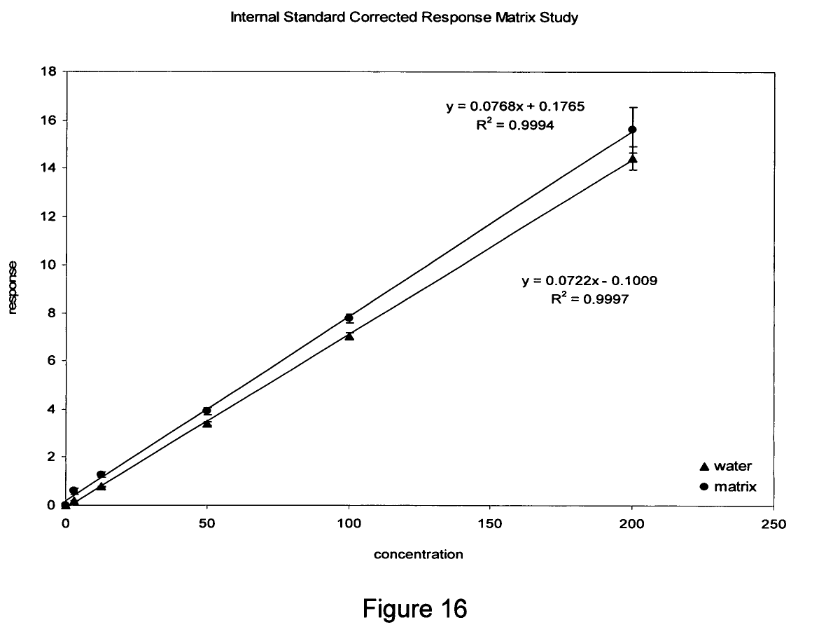

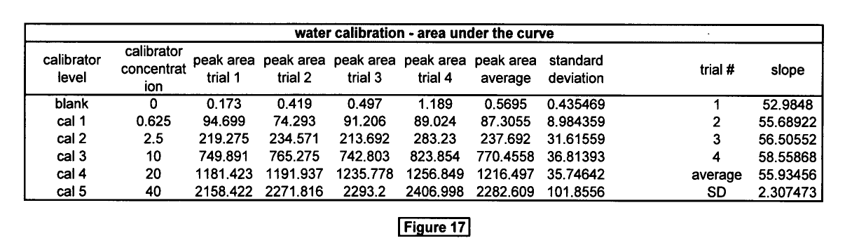

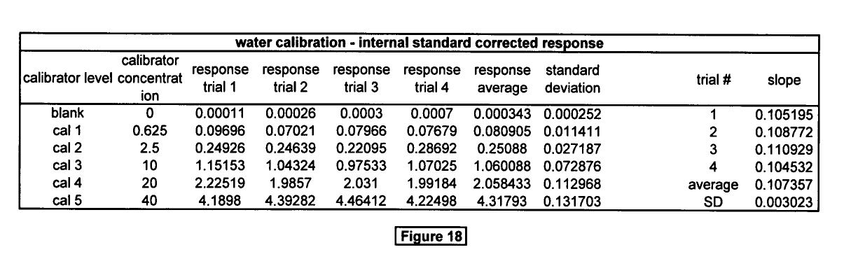

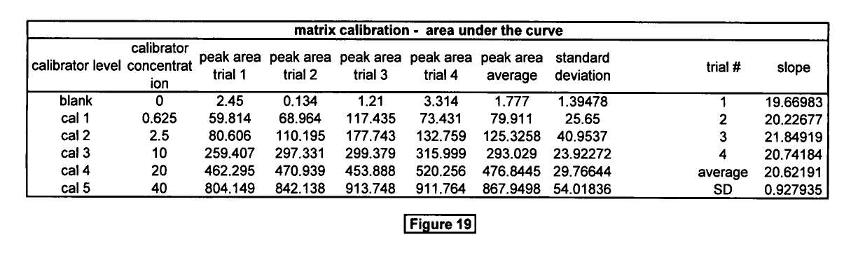

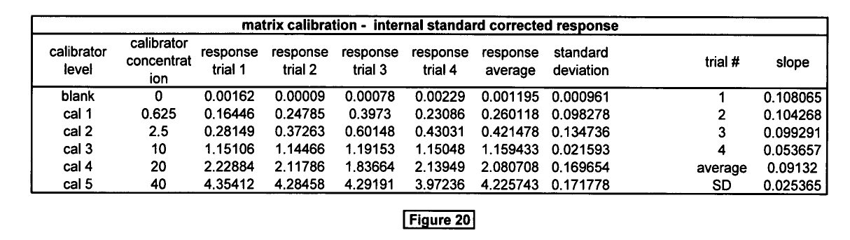

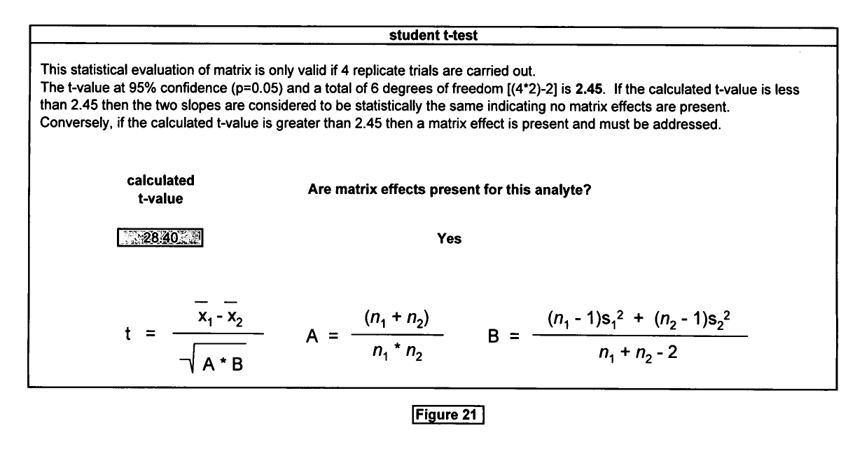

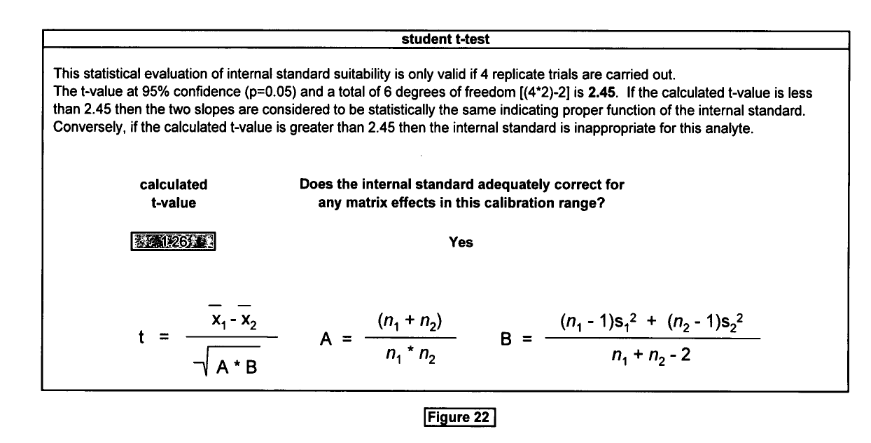

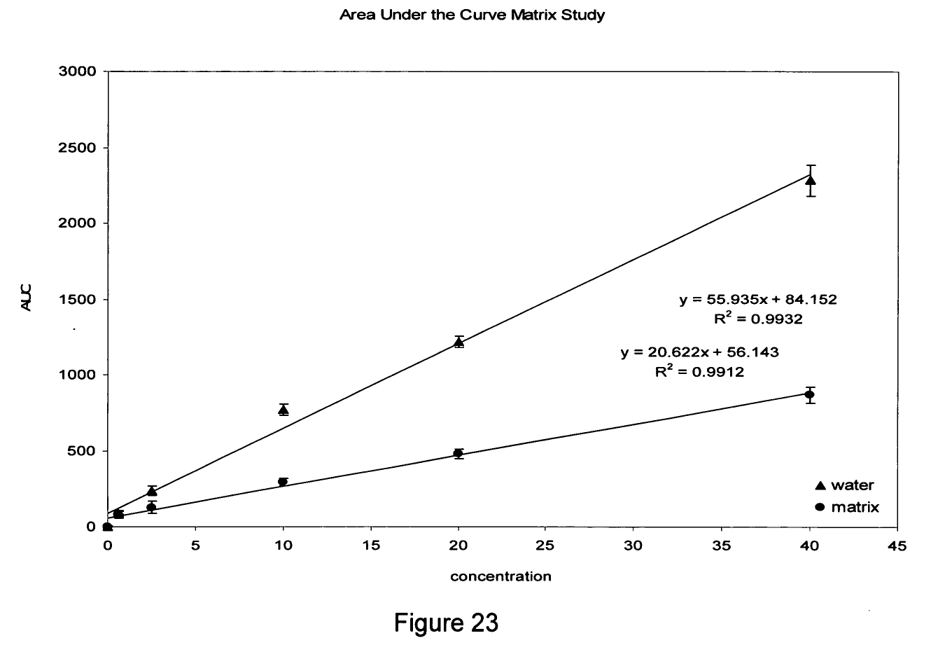

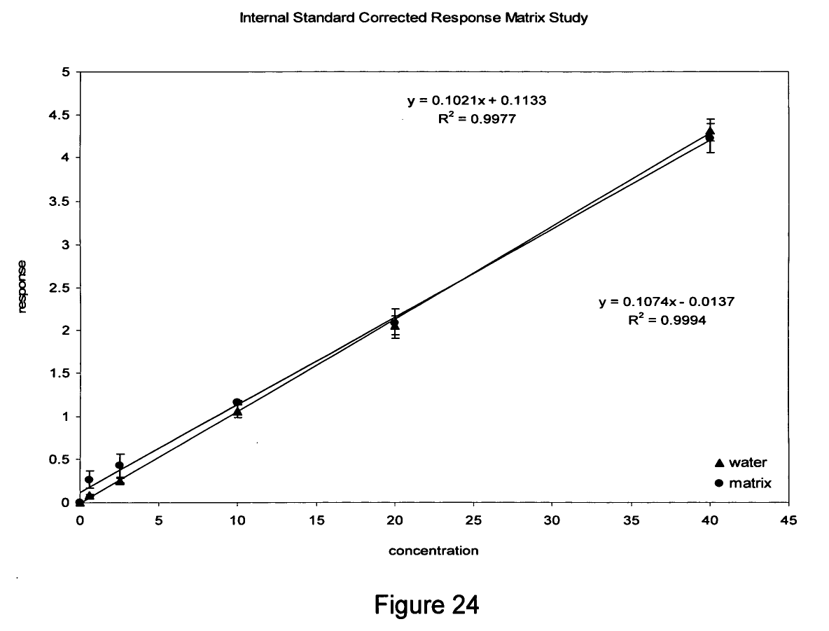

The data for the lactate study is shown in FIGS. 9-16 for L-lactate and in FIGS. 17-24 for D-lactate.

From a statistical comparison of the slopes, the results showed that by utilization of the deuterated internal standard, the effects of matrix are corrected for both D- and L-lactate.

### Example 4

### Evaluation of Interference

An evaluation of interference for D-lactate was conducted. For this, a mixing study using clinical urine samples with differing amounts of D-lactate was carried out utilizing the optimized experimental conditions.

TABLE 7
Evaluation of interference

| | Creati- | | | | |
|---|---|---|---|---|---|
| Sample # | nine^{a} | D-lactate^{b} | D-lactate^{c} | L-lactate^{b} | L-lactate^{c} |
| A0708160068 | 133.2 | 1.5 | 1.2 | 21.8 | 16.4 |
| A0708160059 | 77.3 | 16.4 | 21.0 | 23.6 | 30.5 |
| 1:1 mix | N/A | 9.0 | N/A | 22.7 | N/A |
| expected | | | | | |
| 1:1 mix | N/A | 9.0 | N/A | 22.6 | N/A |
| observed | | | | | |
| % difference | | 0 | | 0.2 | |
| expected vs | | | | | |
| observed | | | | | |

^{a}Cobas (mg/dL);
^{b}LC/MS/MS mg/L, average n = 3;
^{c}μg/mg creatinine

A 1+1 mixture of a urine specimen containing normal D-lactate (e.g., 1.2 μg/mg creatinine, Sample A0708160068, Table 7) and elevated D-lactate (e.g., 21.0 μg/mg creatinine, Sample A0708160059, Table 7) were mixed together and then all samples were analyzed in triplicate. In addition, an interference evaluation for L-lactate of the same patient samples is provided. In order to prove that no endogenous interference is present, the expected experimental result of the combined samples should match the observed experimental result. If these values do not agree closely, this will suggest the presence of interfering substance. The results of the study shown in Table 7 indicates that when the two patient samples are combined, for both D- and L-lactate, a value of half of the sum of the original combined concentrations is obtained. For example, the expected concentration for mixed D-lactate is 9.0 mg/L (e.g., 1.5+16.4/2=9.0 mg/L) which agrees exactly (i.e., 0% difference) with the experimental result for these mixed samples=9.0 mg/L. Similarly, for L-lactate, the expected combined value of 22.7 mg/L (e.g., 21.8+23.6/2=22.7 mg/L) agrees very closely to the experimental value of 22.6 mg/L with only 0.2% difference. Therefore, it can be concluded that there are no substantial interference for analysis of D- and L-lactate in patient urine samples.

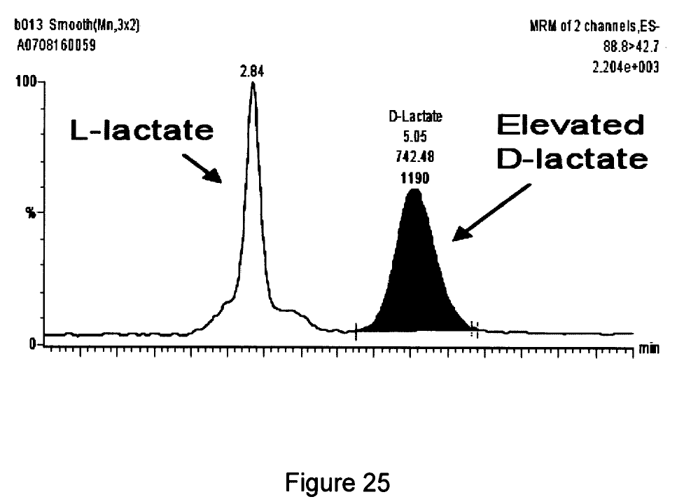

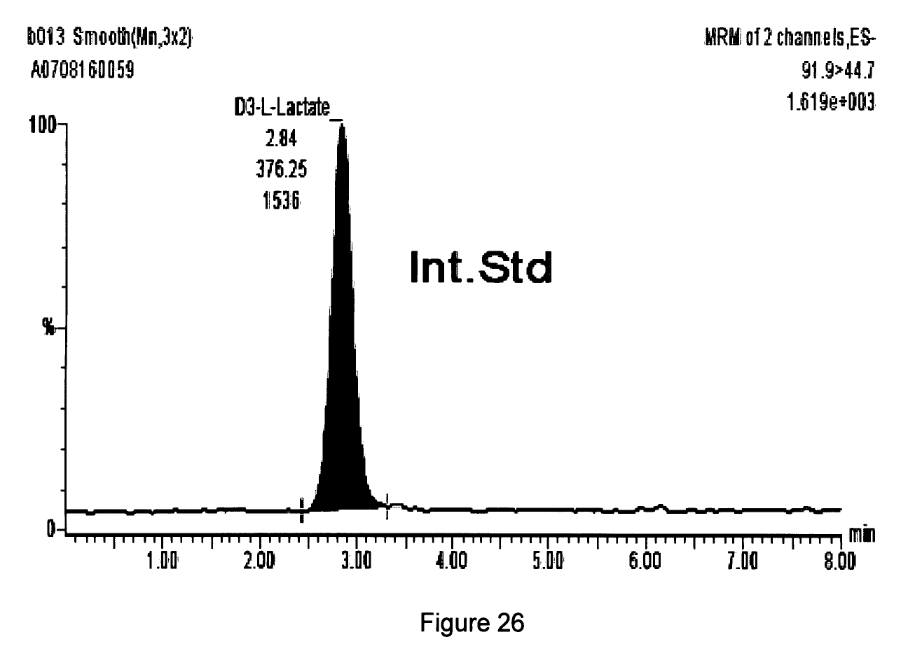

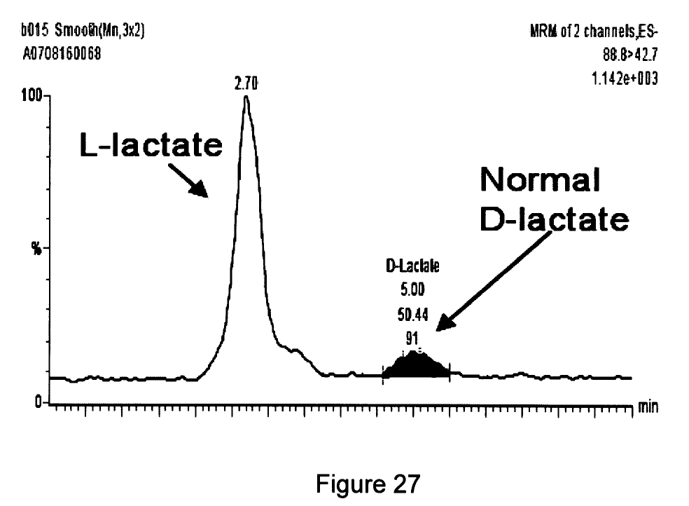

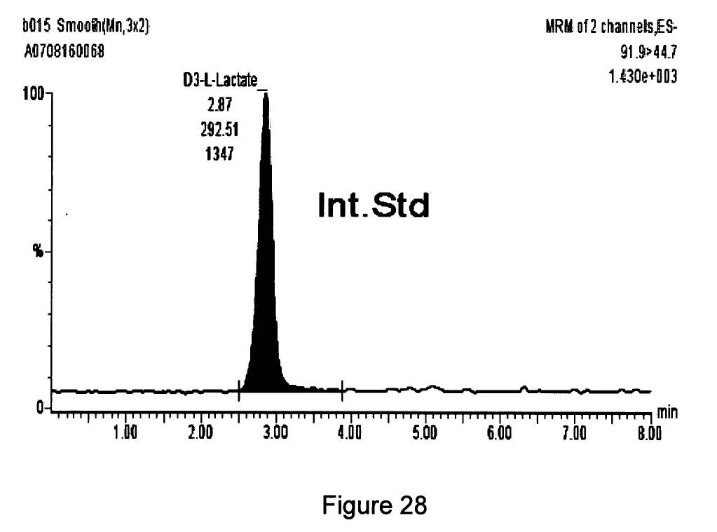

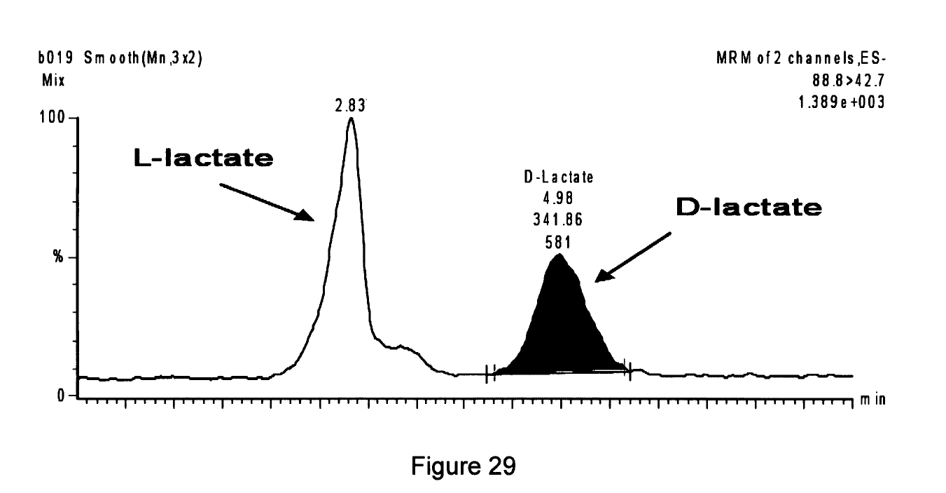

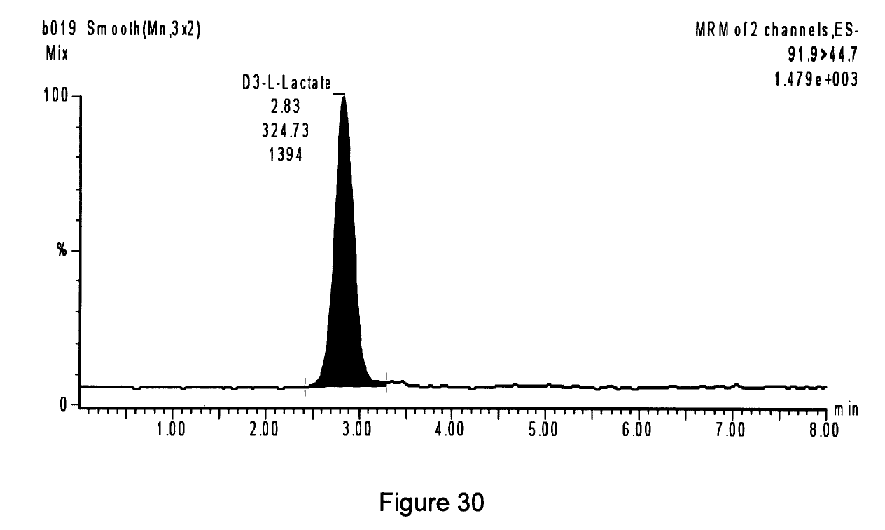

FIGS. 25-30 show graphs of patient sample data and mixed patient samples. This interference study indicates that essentially no meaningful amount of endogenous substance is present in the urine specimen to interfere with D- and L-lactate.

One aspect of the method described in the present disclosure allows for rapid and sensitive analysis of both L- and D-lactic acid in urine following a quick and easy sample preparation. One exemplary embodiment of the mobile phase conditions used is: 17% H₂O, 83% EtOH containing 0.115% HOAc and 0.3% TEA delivered isocratically at 0.2 mL/min. A matrix study was performed which showed that minor variation due to sample matrix was corrected for using the deuterated internal standard. The LOD for L-lactic acid was found to be 0.2 mg/L with LOQ of 0.5 mg/L. For D-lactic acid, the LOD was found to be 0.4 mg/L with LOQ of 1.3 mg/L. The linearity of the calibration curves was found to be acceptable with low observable error and r² correlation of greater than 0.9940 for both enantiomers. Patient ranges varied from 1-85 μg/mg creatinine of L-lactic acid and from 0-40 μg/mg creatinine of D-lactic acid which are comparable to those established in the literature. A summary of the spiking and recovery experiment showed average recovery to be 86.5% for L-lactic acid and 100.4% for D-lactic acid. The precision of the method was evaluated using normal and elevated controls. For the within run precision (n=10 replicate runs), the % RSD was found to be overall lower than 6% RSD. The between run precision (n=2) measured over ten days was slightly higher with % RSD no greater than 14.5%. Finally, the short and long term stability of the patient sample was evaluated and was deemed to be stable for three days stored on-instrument and also when refrigerated or frozen for greater than 2 weeks.

Our preliminary research discussed herein covered the following mobile phase conditions: 1) 40 EtOH 0.4% TEA/0.1% AcAcid plus 60 MeOH 0.4% TEA/0.1% Ac Acid Flow Rate 0.25 mL/min (2300 PSI), 2) 100% MeOH 0.15% Acetic Acid, 0.3% TEA, 3) 100% EtOH 0.15% Acetic Acid, 0.35% TEA, 4) MeOH+NH4OAc (0.1%-0.5%) flow 0.4 mL/min 5) Effect of Adding MeOH 0.5% NH4OAc into 100% EtOH a) 50EtOH 50MeOH, 0.5% NH4OAc flow 0.35 mL/min, b) 40EtOH 60 MeOH 0.5% NH4OAc flow 0.35 mL/min, c) 60 EtOH 40MeOH 0.5% NH4OAc flow 0.4 ml/min, d) 80EtOH, 20 MeOH 0.5% NH4OAc flow 0.4 mL/min. The method of the present invention has the potential to indicate disease state if the patient sample exhibits extremely high peak areas following normalization to creatinine.

The method of the present invention provides an LC/MS method appreciably faster than conventional methods of analysis. The method of the present invention provides an LC/MS method which does not appreciably contaminate the ion source.

The present disclosure also provides a system for analyzing enantiomeric mixtures of D-lactic acid and L-lactic acid. at least one chromatographic column which at least one macrocyclic glycopeptide chiral material is associated; and, at least one mobile phase material. The mobile phase may comprise, in one exemplary embodiment, short chain alcohols. In one exemplary embodiment the mobile phase material comprises at least one short chain alcohol, at least one volatile salt, and an acid. In another exemplary embodiment, the mobile phase material comprises 17% of a mobile phase A, where said mobile phase A comprises deionized H₂O; 23% of a mobile phase B, where said mobile phase B comprises EtOH+0.5% (v/v) HOAc; and, 60% of a mobile phase C, where said mobile phase C comprises EtOH+0.5% (v/v) TEA.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. It should further be noted that all patents, applications, literature references and publications referred to herein as well those referred to in the provisional patent application upon which the present application claims priority are incorporated by reference in their entirety.

Claimed is:

1. A method for separation of D-lactic acid and L-lactic acid enantiomers, comprising:
a. providing a column with which chirobiotic teicoplanin aglycone is associated;
b. passing a test sample suspected of containing D-lactic acid and L-lactic acid enantiomers over said column;
c. performing high performance liquid chromatography separation analysis on said test sample; and,
d. performing tandem mass spectrometry analysis on said test sample.

2. The method of claim 1, wherein the acetic acid/triethylamine content is 0.115% HOAc and 0.3% TEA.

3. The method of claim 1, further comprising quantifying the amounts of said D-lactic acid and L-lactic acid present in said test sample.

4. The method of claim 1, further comprising adding water to a polar organic mobile phase.

5. The method of claim 1, wherein a mobile phase comprises short chain alcohols.

6. The method of claim 5, wherein said short chain alcohols are selected from the group consisting of methanol, ethanol and isopropanol.

7. The method of claim 5, wherein said mobile phase further comprises at least one volatile salt.

8. The method of claim 7, wherein said volatile salt comprises an ammonium salt.

9. The method of claim 5, wherein said mobile phase further comprises an acid.

10. The method of claim 9, wherein said acid comprises acetic acid.

11. The method of claim 1, further comprising quantifying the amount of D-lactic acid and L-lactic acid present in said test sample.

12. The method of claim 7, further comprising correlating the level of D-lactic acid or L-lactic acid with the presence of bacteria in a patient.

13. The method of claim 5, wherein said mobile phase comprises
a. 17% of a mobile phase A, where said mobile phase A comprises deionized H₂O,
b. 23% of a mobile phase B, where said mobile phase B comprises EtOH+0.5% (v/v) HOAc, and
c. 60% of a mobile phase C, where said mobile phase C comprises EtOH+0.5% (v/v) TEA.

14. The method of claim 5, wherein said mobile phase C comprises 17% H₂O, 0.115% HOAc in EtOH and 0.3% TEA in EtOH.

15. The method of claim 5, wherein said macrocyclic glycopeptide chiral material is selected from the group consisting of chirobiotic teicoplanin aglycone and vancomycin.

16. A method for separation of D-lactic acid and L-lactic acid enantiomers, comprising:
a. providing a column with which a macrocyclic glycopeptide chiral material is associated;
b. passing a test sample suspected of containing D-lactic acid and L-lactic acid enantiomers over said column; and,
c. performing high performance liquid chromatography and tandem mass spectrometry (HPLC/MS/MS) analysis on said test sample.

17. The method of claim 16, wherein said chiral material is chirobiotic teicoplanin aglycone.

18. A method for simultaneous and sensitive determination of D-lactic acid and L-lactic acid enantiomers in human urine, comprising:
a. providing a column with which chirobiotic teicoplanin aglycone is associated;
b. passing a test sample suspected of containing D-lactic acid and L-lactic acid enantiomers over said column;
c. performing high performance liquid chromatography separation analysis on said test sample; and,
d. performing tandem mass spectrometry analysis on said test material.

19. A method for detecting bacterial presence or growth in a patient by detecting D-lactic acid or D-lactate in a test sample, comprising:
a. providing a column with which chirobiotic teicoplanin aglycone is associated;
b. passing a test sample suspected of containing D-lactic acid and L-lactic acid enantiomers over said column;
c. performing high performance liquid chromatography separation analysis on said test sample; and,
d. performing tandem mass spectrometry analysis on said test material.

20. A method for detecting elevated levels of L-lactic acid and D-lactic acid in a patient specimen and correlating said elevated levels to an illness, comprising:
a. providing a column with which chirobiotic teicoplanin aglycone is associated;
b. passing a test sample suspected of containing D-lactic acid and L-lactic acid enantiomers over said column;
c. performing high performance liquid chromatography separation analysis on said test sample; and,
d. performing tandem mass spectrometry analysis on said test material.

21. A system for detecting elevated levels of L-lactic acid and D-lactic acid in a patient specimen, comprising:
a. at least one chromatographic column which at least one macrocyclic glycopeptide chiral material is associated; and,
b. at least one mobile phase material.

22. The system of claim 21, further comprising a mobile phase comprising short chain alcohols.

23. The system of claim 21, wherein said at least one mobile phase material comprises
a. at least one short chain alcohol,
b. at least one volatile salt, and
c. an acid.

24. The system of claim 21, wherein said at least one mobile phase material comprises
a. 17% of a mobile phase A, where said mobile phase A comprises deionized H₂O,
b. 23% of a mobile phase B, where said mobile phase B comprises EtOH+0.5% (v/v) HOAc, and
c. 60% of a mobile phase C, where said mobile phase C comprises EtOH+0.5% (v/v) TEA.

25. The system of claim 21, wherein said macrocyclic glycopeptide chiral material is selected from the group consisting of chirobiotic teicoplanin aglycone and vancomycin.
